(19) United States
(12) Patent Application Publication
(10) Pub. No.: US 2025/0135581 A1
(43) Pub. Date: May 1, 2025

(54) METHOD AND SYSTEM FOR INCORPORATING A MELTED METAL DROP EJECTING DEVICE IN A HYBRID ADDITIVE MANUFACTURING SYSTEM

(71) Applicant: Additec LLC, Palm City, FL (US)

(72) Inventors: Brian Matthews, Palm Beach Gardens, FL (US); Chu-heng Liu, Penfield, NY (US); Paul J. McConville, Webster, NY (US); Sriram Manoharan, West Palm Beach, FL (US)

(21) Appl. No.: 18/498,870

(22) Filed: Oct. 31, 2023

(51) Int. Cl. B23K 26/342; B23K 26/70; B33Y 30/00

(52) U.S. Cl. CPC B23K 26/342; B23K 26/703; B33Y 30/00

(57) ABSTRACT

A docking mechanism incorporates a melted metal drop ejecting device within a subtractive manufacturing system to form a metal hybrid manufacturing system. The docking mechanism includes connectors for coupling a supply of melted metal and electrical controls to the melted metal drop ejecting device for operation of the device.

### STATEMENT REGARDING FEDERALLY FUNDED RESEARCH OR DEVELOPMENT

Not Applicable.

### TECHNICAL FIELD

This disclosure is directed to hybrid manufacturing systems that produce three-dimensional (3D) objects and, more particularly, to operation of a metal drop ejecting system and a metal deposition system to form three-dimensional (3D) metal objects.

### BACKGROUND

Three-dimensional printing, also known as additive manufacturing, is a process of making a three-dimensional solid object from a digital model of virtually any shape. Many three-dimensional printing technologies use an additive process in which an additive manufacturing device forms successive layers of the part on top of previously deposited layers. Some of these technologies use ejectors that eject UV-curable materials, such as photopolymers or elastomers. The printer typically operates one or more ejectors to form successive layers of the plastic material that form a three-dimensional printed object with a variety of shapes and structures. After each layer of the three-dimensional printed object is formed, the plastic material is UV cured and hardens to bond the layer to an underlying layer of the three-dimensional printed object. This additive manufacturing method is distinguishable from traditional object-forming techniques, which mostly rely on the removal of material from a work piece by a subtractive process, such as cutting or drilling.

3D object printers have been developed that eject drops of melted metal from one or more ejectors to form 3D objects. These devices have a source of solid metal, such as a roll of wire, pellets, billets, or ingots, that are fed into a heating chamber where they are melted and the melted metal flows into a chamber of the ejector. The chamber is made of non-conductive material around which an uninsulated electrical wire is wrapped. An electrical current is passed through the conductor to produce an electromagnetic field to cause the meniscus of the melted metal at a nozzle of the chamber to separate from the melted metal within the chamber and be propelled from the nozzle. A platform opposite the nozzle of the ejector is moved in a X-Y plane parallel to the plane of the platform by a controller operating actuators so the ejected metal drops form metal layers of an object on the platform and another actuator is operated by the controller to alter the position of the ejector or platform in the vertical or Z direction to maintain a constant distance between the ejector and an uppermost layer of the metal object being formed. This type of metal drop ejecting printer or device is also known as a magnetohydrodynamic (MHD) printer or device.

Melted metal drop ejecting devices are standalone systems because the environmental conditions useful for forming an object with melted metal drops are extreme. For example, a device that ejects melted aluminum drops maintains the object being manufactured at a temperature of 500° C. or higher. For other melted metals, the temperatures can be as high as 2000° C. Computer numerical control (CNC) systems are known that include a carousel for holding a plurality of subtractive manufacturing tools. The material block from which material is removed to form an article is positioned on a platform, which may have a translation mechanism. When a particular tool is needed for subtractive manufacture, the carousel is rotated to position the selected tool at a spindle and the tool is coupled to the spindle. The spindle is activated to operate the tool to perform lathe operations, drilling, or the like while the platform translation mechanism, tool translation mechanism, or both are operated to move the material block relative to the operating tool. When the subtractive manufacturing operations are completed, the spindle is deactivated and the tool is returned to the carousel until another operation of the tool is needed. Being able to incorporate a melted metal drop ejecting device into a subtractive manufacturing system as a CNC tool compatible with a carousel would be beneficial.

### SUMMARY

A new metal hybrid manufacturing system incorporates a melted metal drop ejecting device into a subtractive manufacturing system having a carousel. The new melted metal drop ejecting device includes a housing mounted to the melted metal drop ejecting device; and an input and output connector panel, the input and output connector panel having a plurality of connectors configured to mate with supplies for materials and electrical power within the melted metal drop ejecting device and to provide signals to an external controller for control of the melted metal drop ejecting device operation.

A new docking station incorporated within a subtractive manufacturing system enables a melted metal drop ejecting device to be used selectively for the manufacture of an object. The new docking station includes a docking mechanism; a housing configured to store the docking mechanism when not in use; a door configured to rotate about a hinge to enable egress of the docking mechanism from the housing; and a first input and output connector panel configured with a plurality of connectors that enable connections to make from the material supply sources and the electrical power sources of the 3D object manufacturing system to a plurality of connectors on a second input and output connector panel of the melted metal drop ejecting device.

### BRIEF DESCRIPTION OF THE DRAWINGS

The foregoing aspects and other features of a hybrid manufacturing system and its operation that enables a melted metal drop ejecting device to be used selectively for manufacture of an object are explained in the following description, taken in connection with the accompanying drawings.

FIG. 1A is a front view of a melted metal drop ejecting device that can be incorporated into a subtractive manufacturing system.

FIG. 1B is a back view of the melted metal drop ejecting device of FIG. 1A that can be incorporated into a subtractive manufacturing system.

FIG. 1C is a bottom view of the melted metal drop ejecting device of FIG. 1A that can be incorporated into a subtractive manufacturing system.

FIG. 2A depicts the loading of the melted metal drop ejecting device of FIG. 1A into a swing arm associated with a CNC carousel.

FIG. 2B shows the position of the melted metal drop ejecting device of FIG. 2A after the swing arm has rotated to move the device to the carousel.

FIG. 2C shows the melted metal drop ejecting device of FIG. 2B loaded into the carousel.

FIG. 3A shows a bottom view of a docking station for enabling operation of the melted metal drop ejecting device of FIG. 1A.

FIG. 3B shows the opening of the docking station of FIG. 3A to expose the docking mechanism.

FIG. 3C shows the extension of an input and output connector panel from the docking mechanism for coupling to the melted metal drop ejecting device of FIG. 1B.

FIG. 3D shows the melted metal drop ejecting device of FIG. 1A in position to be installed for operational use.

FIG. 3E shows the melted metal drop ejecting device of FIG. 3D installed for use.

FIG. 3F shows the melted metal drop ejecting device of FIG. 3E with an insulating collar mounted about the coupler of the melted metal drop ejecting device.

FIG. 3G shows the melted metal drop ejecting device of FIG. 3E connected to the input and output connector panel of the docking mechanism of FIG. 3C.

### DETAILED DESCRIPTION

For a general understanding of the environment for the system and its operation as disclosed herein as well as the details for the device and its operation, reference is made to the drawings. In the drawings, like reference numerals designate like elements.

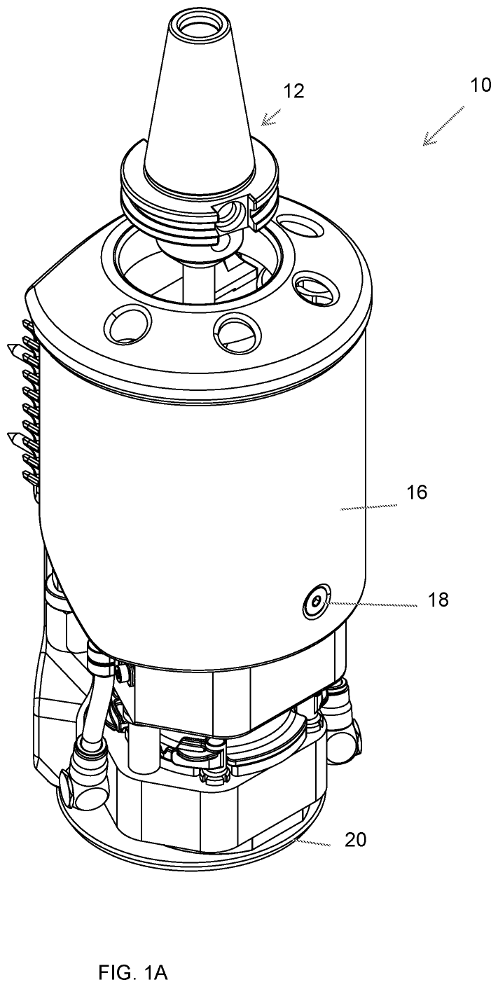

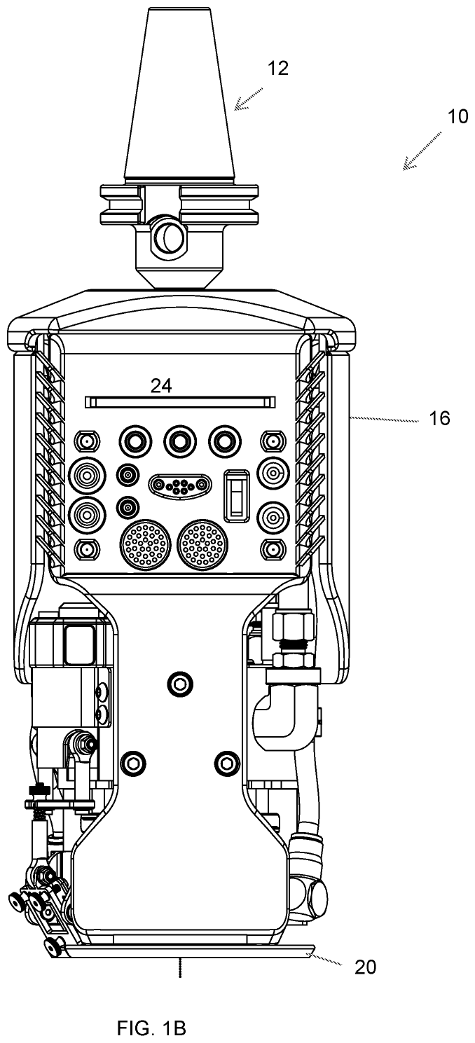

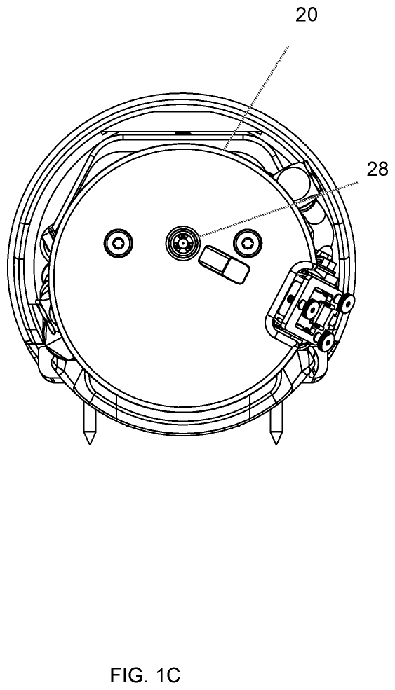

FIG. 1A is a front view of a melted metal drop ejecting device 10 that can be incorporated in a CNC system as described more fully below. The device 10 includes a carousel coupler 12 that fits within a collar of the carousel to hold the device in place as described more fully below. Housing 16 is a generally cylindrical plate that partially covers the melted metal drop ejecting device but the plate is open in the back to enable connections to an input and output connector panel. The housing 16 acts as a heat shield for the device 10, which contains the melted metal vessel and an electrical coil that is activated to produce Lorentz forces in the melted metal held within the melted metal vessel to eject drops of melted metal. The housing 16 is mounted to the device by a threaded member 18. Faceplate 20 includes an aperture and nozzle from which the melted metal drops are ejected.

FIG. 1B is a back view of the melted metal drop ejecting device 10. As noted previously, the housing 16 is open in the back to expose an input and output connector panel 24. This panel organizes the input and output connectors needed to operate the device 10. Some of these connectors provide an input for a feed of stock metal to the device 10 for melting, others provide inputs for electrical power for the feed stock heater to produce melted metal in the device 10, others provide inputs for high current/voltage electrical power to operate the coil within the housing 16, and others provide inputs for electrical power used to operate an object heater. If the object heater is a fiber-coupled laser, then the connector for the object heater may be a fiber coupling connection. Alternatively, if the object heater is a diode laser, then the object heater connection is an electrical connector for electrical power at a sufficient current and voltage level to operate the diode laser. Other connectors in the panel 24 are for coolant flow into and out of the device 10 for cooling the MHD drive coil, the object heater, or both; and a connector may be provided in the panel 24 for a flow of an inert gas, such as argon, to attenuate oxidation of the melted metal. Additionally, connectors may be provided for a thermocouple in the device 10 for monitoring temperature as well as connections for other sensors, such as a sensor for monitoring the level of the liquid metal in the vessel of the device 10, the position of the feedstock metal, the image data of the object's surface, the temperature of the object around the drop deposition location, and the pressure in the vessel.

FIG. 1C is a bottom view of the melted metal drop ejecting device 10. The faceplate 20 includes an aperture 28 in which a nozzle is located. Thus, the melted metal drops are ejected from the nozzle within the aperture 28.

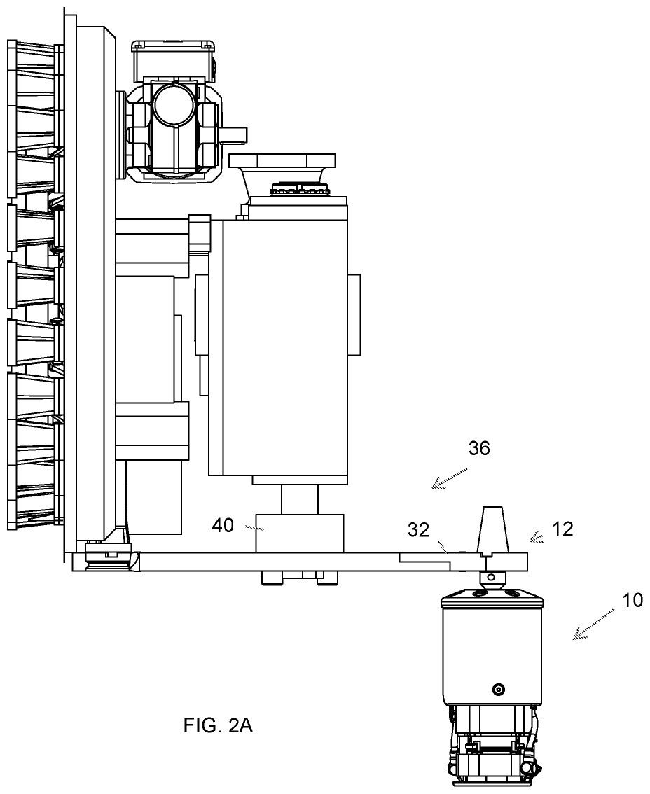

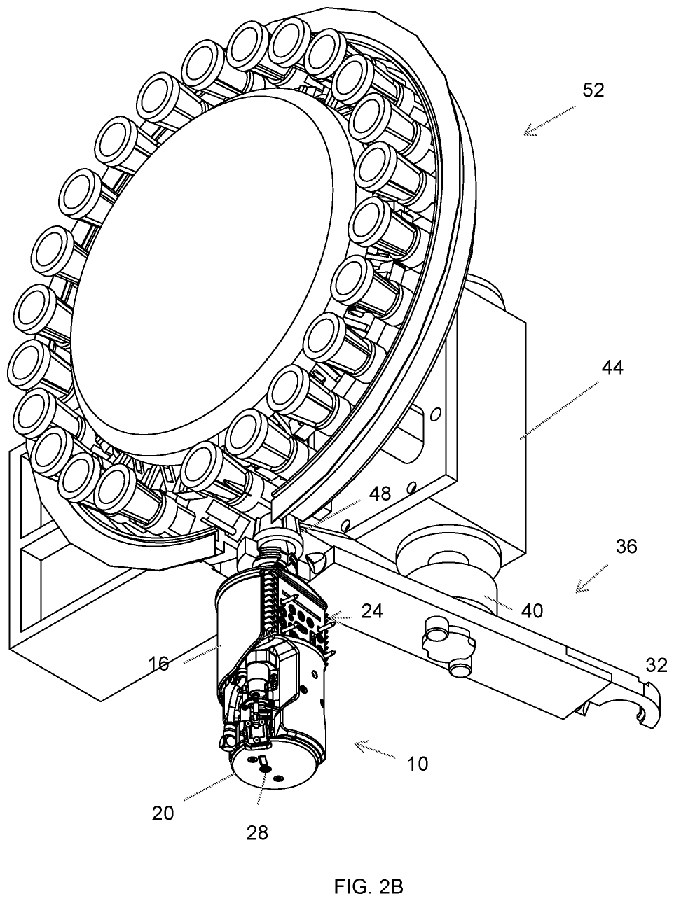

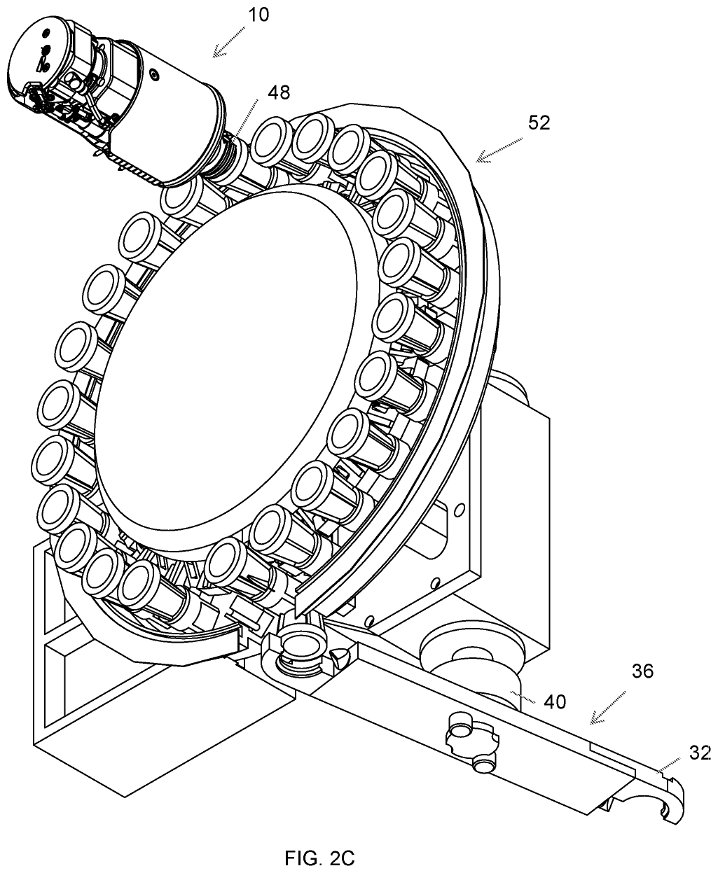

Loading of the device 10 into a carousel of a CNC system is described with reference to FIG. 2A to FIG. 2C. As shown in FIG. 2A, the coupler 12 is slid into a collar 32 located at one end of a swing arm 36. A motor within housing 44 is operated to rotate spindle 40 so the swing arm rotates to the position shown in FIG. 2B. The motor is then operated to retract a portion of the spindle into the housing 44 so the coupler 12 of device 10 is received into a socket 48 of the carousel 52 that has been rotated from the horizontal position to a vertical alignment. Once secured in the socket 48, the swing arm 36 is rotated to release the device 10 and the socket 48 is rotated to the horizontal as shown in FIG. 2C. In FIG. 2C, the carousel 52 has been rotated to a position away from the swing arm 36. While the loading of the device 10 has been described with reference to a carousel having a swing arm, the device 10 can be loaded into systems that do not have a swing arm, such as those in which the tool is manually installed in the spindle.

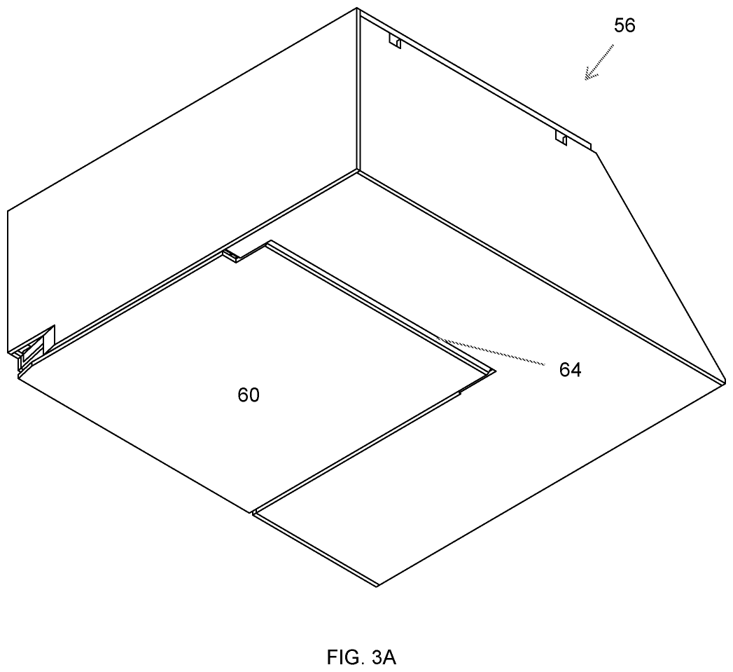

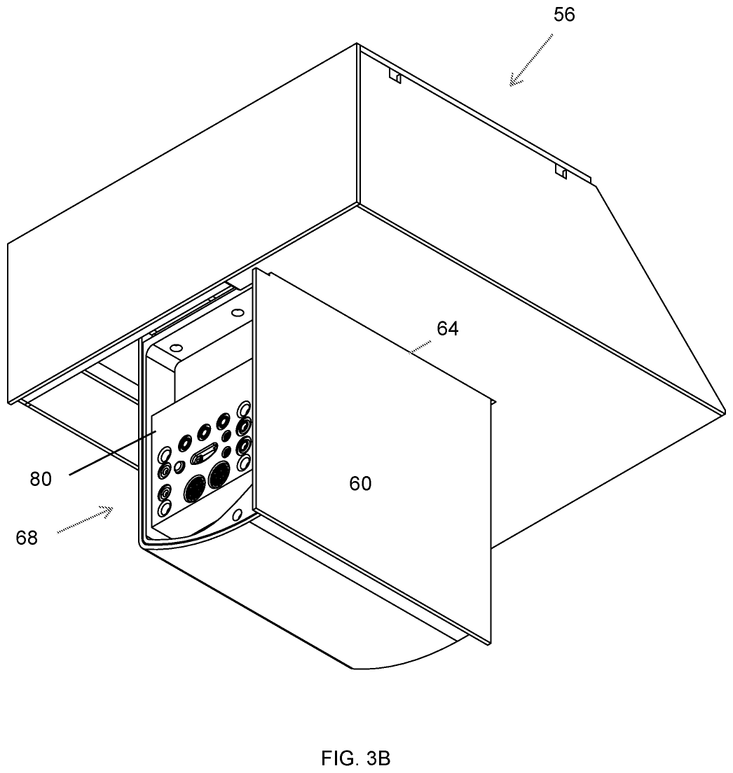

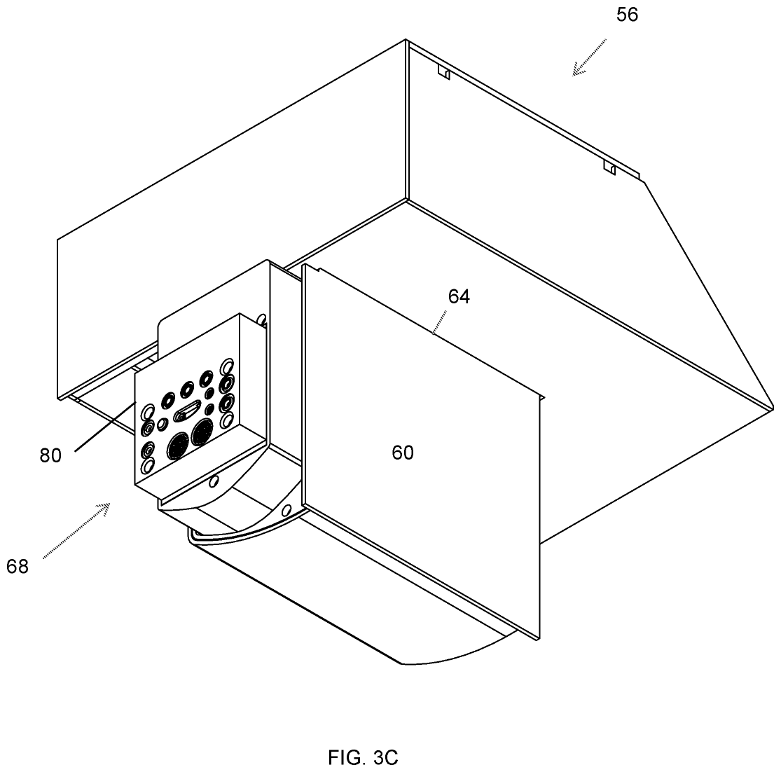

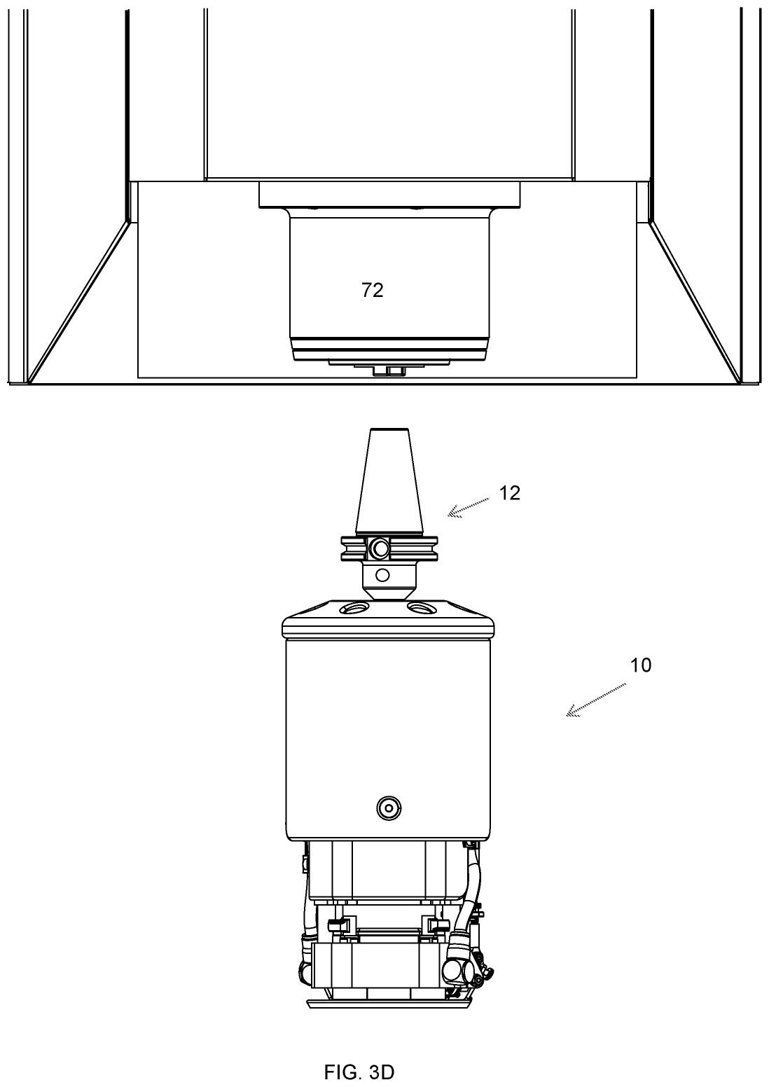

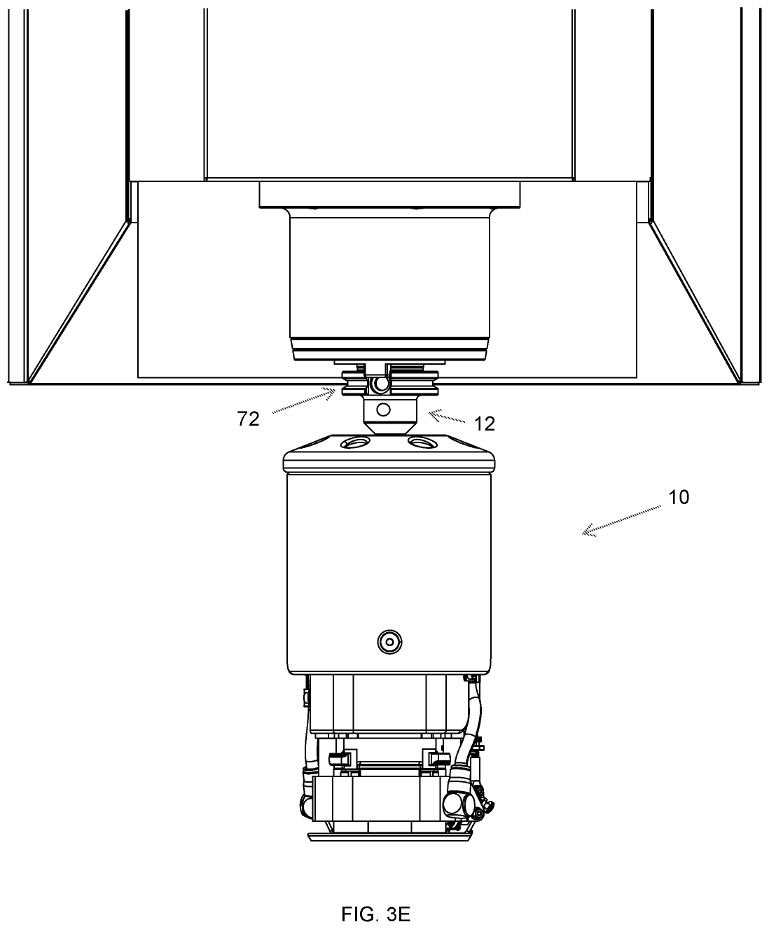

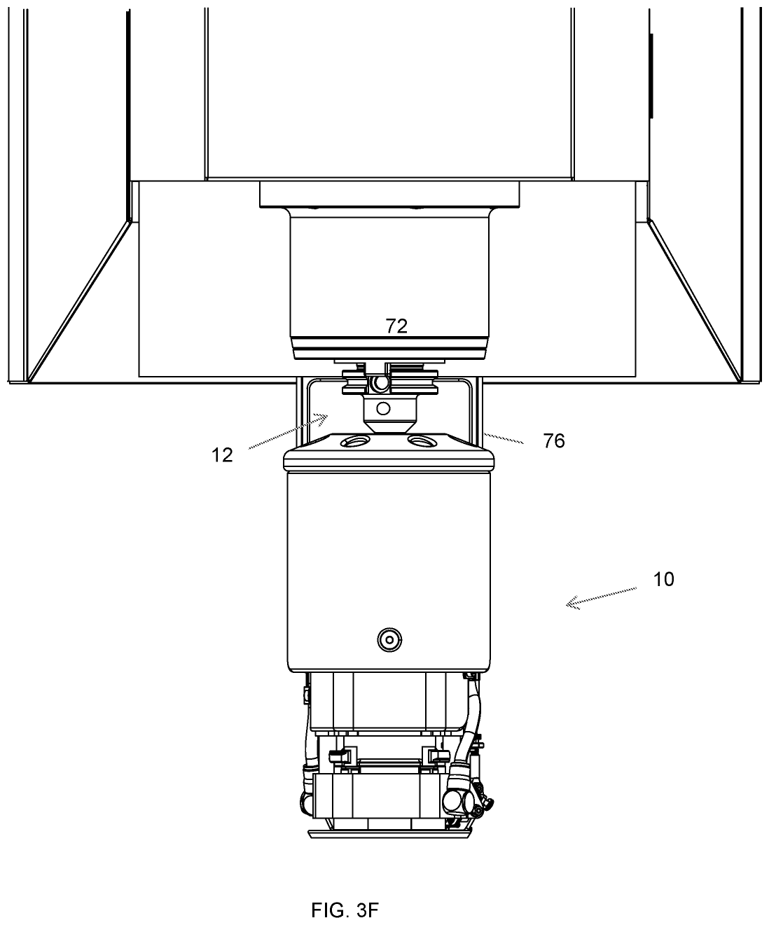

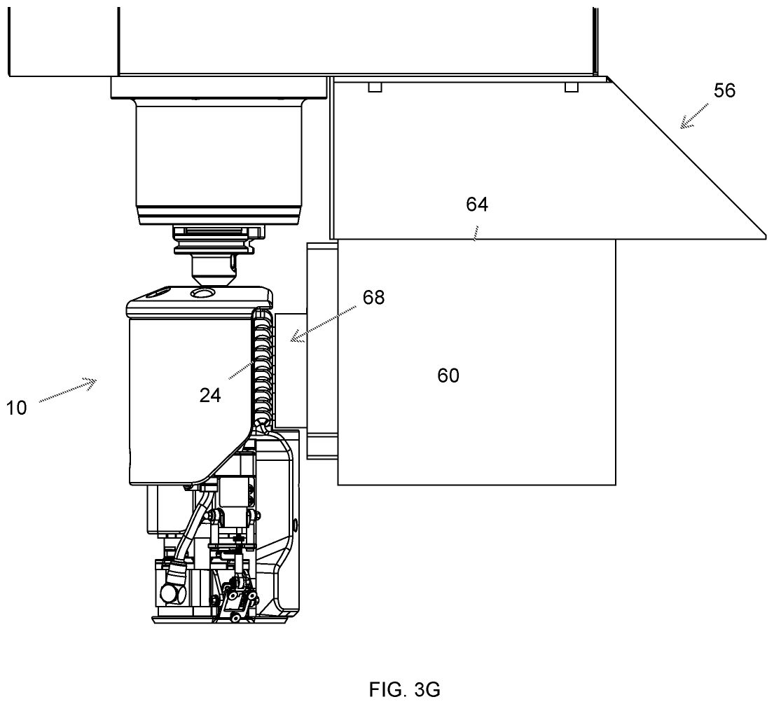

FIG. 3A is a bottom view of a docking station 56 that is operated to make the melted metal drop ejecting device 10 operational. The docking station 56 has a housing that includes a door 60 that rotates about a hinge 64. When the device 10 is to be used to eject melted metal drops to form an object or add features to an object, the door 60 is released so it rotates about the hinge 64 to expose the docking mechanism 68, which is attached to the door 60 as shown in FIG. 3B. A motor within the docking mechanism 68 is then operated to extend the input and output connector panel 80 of the docking mechanism 68 from a retracted position within the docking mechanism to an extended position where the input and output connector panel 24 of the device 10 can be connected to the connectors arranged in the input and output connector panel 80 of the docking mechanism 68 as shown in FIG. 3C. Thus, the docking mechanism is configured to provide connectors for supplying the electrical power, solid metal feed, sensor connections, noble gas, coolant, and other related functions for operating the device 10 in the hybrid manufacturing system.

Prior to the operation of the docking station 56, the device 10 is positioned to be mounted into operational position as shown in FIG. 3D and the coupler 12 is mated with the mounting socket 72 as shown in FIG. 3E. An insulating collar 76 is then mounted about the coupler 12 as shown in FIG. 3F. Once the device 10 has been installed into the system, the docking station 56 and docking mechanism 68 are operated as described above with reference to FIG. 3A to FIG. 3C to enable the connectors of the input and output connector panel 80 to be connected to the connectors of the input and output connector panel 24 of the device 10. The melted metal drop ejecting device 10 can now receive melted metal and be operated by a controller within the docking mechanism 68 to eject melted metal drops toward a metal object being formed on a platform.

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed:

1. A melted metal drop ejecting device configured to be incorporated in a hybrid manufacturing system comprising:
a housing mounted to the melted metal drop ejecting device; and
an input and output connector panel, the input and output connector panel having a plurality of connectors configured to mate with supplies for materials and electrical power within the melted metal drop ejecting device and to provide signals to an external controller for control of the melted metal drop ejecting device operation.

2. The melted metal drop ejecting device of claim 1 wherein the housing is a plate positioned on a side of the melted metal drop ejecting device that is opposite the input and output connector panel.

3. The melted metal drop ejecting device of claim 1, the input and output connector panel further comprising:
a first connector configured to receive a feed of stock metal for melting within the melted metal drop ejecting device; and
a second connector configured to receive electrical power having a voltage level and a current level sufficient to operate a heater to melt the received feed of stock metal within a vessel of the melted metal drop ejecting device.

4. The melted metal drop ejecting device of claim 3, the input and output connector panel further comprising:
a third connector configured to receive electrical power having a voltage level and a current level sufficient to operate an electrical coil within the housing to eject melted metal drops from the vessel within the melted metal drop ejecting device.

5. The melted metal drop ejecting device of claim 4, the input and output connector panel further comprising:
a fourth connector configured to receive electrical power for an object heater.

6. The melted metal drop ejecting device of claim 5 wherein the object heater is a diode laser and the fourth connector is configured to couple the diode laser to the received electrical power.

7. The melted metal drop ejecting device of claim 5 wherein the object heater is a fiber-coupled laser, the input and output connector panel further comprising:
a fifth connector configured as a fiber coupling connector.

8. The melted metal drop ejecting device of claim 5, the input and output connector panel further comprising:
a fifth connector configured to received a flow of coolant flow for cooling the electrical coil within the housing; and
a sixth connector configured to permit coolant to leave the housing after circulating within the housing.

9. The melted metal drop ejecting device of claim 8, the input and output connector panel further comprising:
a seventh connector configured to receive a flow of an inert gas to attenuate oxidation of melted metal.

10. The melted metal drop ejecting device of claim 9, the input and output connector panel further comprising:
at least one connector configured to transmit sensor signals.

11. The melted metal drop ejecting device of claim 10 wherein the at least one connector transmits one of a temperature signal and a signal indicating a level of melted metal in the vessel of the melted metal drop ejecting device.

12. A docking station configured to couple a melted metal drop ejecting device to material supply sources and electrical power sources in a 3D object manufacturing system, the docking station comprising:
a docking mechanism;
a housing configured to store the docking mechanism when not in use;
a door configured to rotate about a hinge to enable egress of the docking mechanism from the housing; and
a first input and output connector panel configured with a plurality of connectors that enable connections to make from the material supply sources and the electrical power sources of the 3D object manufacturing system to a plurality of connectors on a second input and output connector panel of the melted metal drop ejecting device.

13. The docking station of claim 12 wherein the first input and output connector panel is further configured to:
extend from a first position within the docking mechanism to a second position outside the docking mechanism to facilitate coupling of the connectors in the second input and output connector panel to the connectors of the first input and output connectors.

14. The docking station of claim 13, the first input and output connector panel further comprising:
a first connector configured to feed solid metal to the melted metal drop ejecting device; and
a second connector configured to provide electrical power having a voltage level and a current level sufficient to operate a heater to melt the metal within a vessel of the melted metal drop ejecting device.

15. The docking station of claim 14, the first input and output connector panel further comprising:
a third connector configured to provide electrical power having a voltage level and a current level sufficient to operate an electrical coil within the melted metal drop ejecting device to eject melted metal drops from the vessel within the melted metal drop ejecting device.

16. The docking station of claim 15, the first input and output connector panel further comprising:
a fourth connector configured to provide electrical power for an object heater.

17. The docking station of claim 16 wherein the fourth connector is configured to couple the electrical power to a diode laser within the melted metal drop ejecting device to operate the diode laser as the object heater.

18. The docking station of claim 16, the first input and output connector panel further comprising:
a fifth connector configured to couple a fiber laser to the melted metal drop ejecting device.

19. The docking station of claim 16, the first input and output connector panel further comprising:
a fifth connector configured to provide a flow of coolant for cooling the electrical coil within the melted metal drop ejecting device; and
a sixth connector configured to permit the coolant to leave the melted metal drop ejecting device after circulating within the melted metal drop ejecting device.

20. The docking station of claim 19, the first input and output connector panel further comprising:
a seventh connector configured to provide a flow of an inert gas to the melted metal drop ejecting device to attenuate oxidation of melted metal.
